(19) United States
(12) Patent Application Publication
(10) Pub. No.: US 2023/0002570 A1
(43) Pub. Date: Jan. 5, 2023

(54) COMPRESSION LIMITER

(71) Applicant: DSM IP Assets B.V., HEERLEN (NL)

(72) Inventors: Jeff HARDING, ECHT (NL); Adnan HASANOVIC, ECHT (NL); Benjamin VAN WISSEN, ECHT (NL)

(21) Appl. No.: 17/781,828

(22) PCT Filed: Dec. 3, 2020
(86) PCT No.: PCT/EP2020/084561

§ 371 Date: Jun. 2, 2022

Related U.S. Application Data
(60) Provisional application No. 62/950,300, filed on Dec. 19, 2019.

(30) Foreign Application Priority Data
Dec. 5, 2019 (EP) 19213769.3

(51) Int. Cl. C08J 5/04; C08G 69/26; F16B 5/02; B29C 45/00; B29C 45/14

(52) U.S. Cl. CPC C08J 5/043; C08G 69/265; F16B 5/02; B29C 45/0001; B29C 45/14786; C08J 2377/06; B29K 2077/00

(57) ABSTRACT

The present invention relates to a compression limiter made of a first thermoplastic composition comprising a semi-crystalline semi-aromatic polyamide. The invention further relates to a process for producing the compression limiter, and to an assembly comprising the compression limiter and a thermoplastic body made of a second thermoplastic polyamide composition. According to the invention, the compression limiter is made of a thermoplastic composition.

The present invention relates to a compression limiter. The invention further relates to a process for producing the compression limiter, and to an assembly comprising a thermoplastic body and the compression limiter. According to the invention, the compression limiter is made of a thermoplastic composition.

Plastic components can be fixed into or onto a carrier, for example an engine of a vehicle, using screws or bolts. Compression limiters are designed for high load bearing capability, thereby protecting the plastic components of an assembly from the compressive loads generated by the tightening of bolts and assuring continued integrity of the bolted connection.

Compression limiters ensure that the normal force of the screw is limited with respect to the plastic component's permissible load, and in doing so, they protect the components from damage. The load causes compression due to tightening torque, which without compression limiters can lead to cracking and creep or otherwise damage the thermoplastic body. Compression limiters also ensure that the normal force of the screw is maintained to an adequate degree over the life of the fastened joint.

Compression limiters are typically plain hole metal inserts designed for use in plastic molded components. The plain hole provides bolt clearance and the wall of the compression limiter withstands the compressive force induced during the assembly of the mating screw or bolt. In practice, the compression limiter should be slightly shorter than the thickness of the plastic host.

As the bolt is tightened the plastic compresses and the stress in the plastic increases until the head of the bolt, or washer if one is used, comes into contact with the compression limiter. Thereafter, the compression limiter and plastic will compress at the same, although greatly reduced, rate. The compression limiter will absorb additional clamping loads without further significant compression or increased stress in the plastic material.

Assemblies comprising a thermoplastic body and one or more compression limiters can be made by insert-molding, i.e. the compression limiters are positioned in place in a mold after which the thermoplastic body is molded around the compression limiters by injection molding, or the compression limiters can be inserted after the thermoplastic body is molded. Installation can take place manually or automatically.

A general problem with compression limiters is proper engagement between the compression limiter and the main body receiving compression limiter. A further problem with many compression limiter systems is the dimensional match between compression limiter and the aperture receiving the compression limiter. A too small aperture or a too large sized compression limiter can lead to damage of the thermoplastic body when putting the compression limiter in place by pressing. On the other hand, a too large aperture or a too small sized compression limiter can lead to too lose connection between the two and result in problems in further handling and mounting or in pull off of the thermoplastic body during operation. Use of an adhesive to overcome these latter problems is also not desirable, as it requires an extra operation and sensitive to failure as well.

An assembly comprising a body part and compression limiters is described for example in US2018261812-A1. The assembly of US2018261812-A1 is a battery assembly for an electrified vehicle. The battery assembly includes one or more compression limiters configured to engage a structural member of the battery assembly. The compression limiters carry loads within the battery assembly and guide fasteners for mating parts of the assembly. The compression limiter includes a body and an attachment head near a first end of the body. Proper engagement of the compression limiter to the structural member of the battery assembly is accomplished with a special configuration of the compression limiter.

Another example of a compression limiter is described in US2008157483-A1. US2008157483-A1 relates to a compression limiter and, more particularly, to a compression limiter utilized to transmit loads of a plastic component. The compression limiter is made of metal. As mentioned in US2008157483-A1, a metal compression limiter is commonly used in applications where a compressive load is applied to a plastic component. The compression limiter strengthens the plastic and resists the load that is applied. The integrity of the plastic, therefore, is not compromised. Additionally, the compression limiter prevents/reduces plastic material creep which can cause reduction of the fastener tightening torque over time. However, according to US2008157483-A1, there are still problems to be solved. Typically, the metal compression limiter is pressed into a bore in the plastic component and receives the fastener. Retention of the pressed-in compression limiter to the plastic component is of concern because they often fall-out prior to final installation of the plastic component. Additionally, the pressed-in compression limiter can press into and deform the material of the second component to which the plastic component is secured, reducing the applied load of the fastener. In motor vehicles and other applications, the plastic component typically has at least three attachment holes receiving the fasteners. One of the holes is typically a datum hole with a smaller diameter that locates the plastic component, one of the holes is a slotted hole that orients the plastic component, and at least one of the holes is a clearance hole for retention of the plastic component to the other component. This requires at least three different compression limiters for a single plastic component which results in a risk that the compression limiters can be inserted in the wrong holes. As a solution to these problems, the compression limiter of US2008157483-A1 includes, in combination, a tubular-shaped wall having an outer surface and an inner surface forming a central passage, and a plurality of perforations extending through the wall from the outer surface to the inner surface.

A further example of a compression limiter is described in US2012107659-A1. US2012107659-A1 relates to a battery pack and more particularly to a battery pack including a prismatic repeating frame assembly comprising a main body having an aperture formed therein; and a hollow compression limiter disposed in the aperture of the main body and permitting a compression rod to be inserted therethrough. According to US2012107659-A1, metallic compression limiters are necessarily machined separately from the repeating frame assemblies. A high degree of cleanliness is desirable for the battery pack, and the machined metallic compression limiters can undesirably introduce debris such as metallic flakes into the battery pack during the insertion process. The metallic compression limiters can also oxidize over time, and further contaminate the battery pack. The use of the heat insertion equipment for installation of the metallic compression limiters also adds to a complexity of the battery pack assembly. The prismatic repeating frame assembly of US2012107659-A1, comprises a main body formed from a first polymer selected from nylon or polypropylene, and a compression limiter formed from a second polymer selected from polyphenylene sulfide (PPS) and a polyether ether ketone (PEEK), made by co-injection molding.

Injection molded parts generally suffer from weak spots at weldlines resulting from the injection molding process. Apart from the above problems with compression limiters in general, compression limiters made of metal are preferred over compression limiters made of plastics, because of their high load bearing properties and in particular for their better performance at elevated temperatures and under dynamic conditions. Whereas the requirements on compression limiters in terms of load bearing properties and prevention of damage of plastic components of an assembly from the compressive loads generated by the tightening of bolts is already high, these requirements are even more severe for under-the-hood applications in vehicles, where assemblies may be mounted close to or even onto the engine. Herein the tight mounting is generally not only to keep the mounted assembly in place, but also secure a leak-tight sealing, for example to prevent leakage of coolant fluid in the assembled battery pack. Herein the mounted assemblies not only have to perform under dynamic mechanic loads due to vibrations from the vehicles in operation at room temperature, but also under different thermal conditions, both at low temperatures, e.g. at −30° C. and even below, and at elevated temperatures as high as 120° C. or even 150° C. and even above, with peak temperatures up to or even above 180° C., as well as under dry conditions and humid conditions, and all combinations thereof, even up to 80 to 100% relative humidity at for example 80° C. Furthermore, dimension control of the compression limiter in combination with the dimensions of the aperture in the plastic body comprising the compression limiter are critical, not only during assembly, but also during these variations in temperature and in humidity.

Therefore, the aim of the present invention is to provide a compression limiter, and an assembly comprising a thermoplastic body and the compression limiter, that show high load-bearing properties over a wide temperature range, for instance that show high static compression failure force and high retention of compression force, this indicating good sealing performance under a wide range of thermal and/or humidity variations.

This aim is achieved with the compression limiter and with the assembly according to the present invention.

The compression limiter according to the invention is made of a first thermoplastic polyamide composition as mentioned in claim 1.

Herein the compression limiter is made of a thermoplastic material comprising
(A) 35-65 wt. % of a polyamide component (A), wherein at least 90 wt. % of the polyamide component (A) consists of a semi-crystalline semi-aromatic polyamide (A-1), consisting of repeat units derived from
   45-50 mole % of a diamine,
   40-50 mole % of an aromatic dicarboxylic acid; and
   0-10 mole % of one or more other monomers,
wherein the mole % is relative to the total molar amount of diamine, aromatic dicarboxylic acid and one or more other monomers, and wherein (A-1) has a glass transition temperature (Tg) of at least 110° C. and a melting temperature of at least 280° C.;
(B) 35-65 wt. % of a fibrous reinforcing agent;
   wherein the weight percentages of (A) and (B) are relative to the total weight of the composition.

The assembly according to the invention comprises a thermoplastic body made of a second thermoplastic polyamide composition and further comprises the hereabove mentioned compression limiter.

Herein the assembly is suitably made by first producing the compression limiter by injection molding of the first thermoplastic polyamide composition, and then producing the thermoplastic body by injection molding of a second thermoplastic polyamide composition, and thereby overmolding the compression limiter with the second thermoplastic polyamide composition.

Such production may be carried out as a two-step injection molding process, or as an insert molding process wherein the compression limiter is produced in a separate process and inserted in a mold prior to the overmolding process.

The effects of the compression limiter and the assembly according to the present invention, wherein the compression limiter is made of the first thermoplastic polyamide composition, and the thermoplastic body is made by overmolding the compression limiter with the second thermoplastic polyamide composition, are high load bearing properties over a prolonged time at a wide temperature range, good adhesion between the compression limiter and the thermoplastic body, and a leak-tight sealing during prolonged operation under varying temperature and/or humidity conditions and/or dynamic mechanic loads.

The compression limiter according to the invention is made of a thermoplastic material, also referred to herein as first thermoplastic material, wherein the thermoplastic material comprises 35-65 wt. % of a polyamide component (A); and 35-65 wt. % of a fibrous reinforcing agent (B). Suitable polyamide (A) and manufacturing method thereof are described for instance in WO2018/060271A1.

Herein at least 90 wt. % of the polyamide component (A) consists of a semi-crystalline semi-aromatic polyamide (A-1), consisting of repeat units derived from
45-50 mole % of diamine,
40-50 mole % of aromatic dicarboxylic acid; and
0-10 mole % of one or more other monomers,
   wherein the mole % is relative to the total molar amount of diamine, aromatic dicarboxylic acid and one or more other monomers, and wherein (A-1) has a glass transition temperature (Tg) of at least 110° C. and a melting temperature of at least 280° C.

Preferably, the semi-crystalline semi-aromatic polyamide (A-1), consists of repeat units derived from
45-50 mole % of diamine,
45-50 mole % of aromatic dicarboxylic acid; and
0-5 mole % of one or more other monomers,
   wherein the mole % is relative to the total molar amount of diamine, aromatic dicarboxylic acid and one or more other monomers.

Semi-crystalline polymers are well-known in the prior art and typically have a morphology comprising crystalline domains, characterized by a melting temperature and a melting enthalpy, and amorphous domains characterized by a glass transition temperature.

With the term glass transition temperature is herein understood the temperature, measured the differential scanning calorimetry (DSC) method according to ISO-11357-1/2, 2011, on pre-dried samples in an N₂ (nitrogen) atmosphere with a heating and cooling rate of 20° C./min (“pre-dried” can mean until the mass of the samples remains constant for 3 consecutive days). Herein the Tg is determined from the temperature at the peak of the first derivative (with respect of time) of the parent thermal curve, corresponding with the inflection point of the parent thermal curve.

With the term melting temperature is herein understood the temperature, measured by the differential scanning calorimetry (DSC) method according to ISO-11357-1/3, 2011, on pre-dried samples, in an N₂ (nitrogen) atmosphere with heating and cooling rate of 20° C./min (“pre-dried” can mean until the mass of the samples remains constant for 3 consecutive days). Herein the Tm is calculated from the peak value of the highest melting peak in the second heating cycle.

With the term semi-crystalline in semi-crystalline polyamide is herein understood that the polyamide has a melting temperature (Tm) and a melting enthalpy (ΔHm), as well as a glass transition temperature (Tg). Suitably, the semi-crystalline polyamide has a melting enthalpy of at least 5 J/g, preferably at least 10 J/g, and even more preferably at least 25 J/g.

With the term melting enthalpy (ΔHm) is herein understood the melting enthalpy, measured by the DSC method according to ISO-11357-1/3, 2011, on pre-dried samples in an N₂ (nitrogen) atmosphere with heating and cooling rate of 20° C./min (“pre-dried” can mean until the mass of the samples remains constant for 3 consecutive days). Herein (ΔHm) has been calculated from the surface under the melting peak in the second heating cycle.

In a preferred embodiment of the compression limiter according the invention, the semi-crystalline semi-aromatic polyamide (A-1) has a glass transition temperature (Tg) of at least 120° C., preferably at least 130° C., and preferably of at most 170° C. and a melting temperature of at least 290° C., preferably at least 300° C., and preferably of at most 340° C. More preferably, the Tg is in the range of in the range of 140-170° C. Also more preferably, the Tm is in the range of in the range of 310-340° C.

The semi-crystalline semi-aromatic polyamide (A-1) in the compression limiter according to the invention, suitably comprises at least 70 mole %, of a linear or branched aliphatic C4-C10 diamine, or a cycloaliphatic diamine, or a combination thereof, relative to the total molar amount of diamine. Preferably, at least 70 mole %, more preferably at least 80 mole % of the diamine consists of a linear aliphatic C4-C10 diamine, or a cycloaliphatic diamine, or a combination thereof. Examples of C4-C10 linear aliphatic diamines are 1,4-diaminobutane, 1,6-hexanediamine, 1,8-octamethylenediamine and 1,10-decamthethylenediamine. Cycloaliphatic diamines include 1,4-cyclohexanediamine and isophoronediamine. An example of a branched aliphatic diamine is 2-methylpentamethylenediamine.

The semi-crystalline semi-aromatic polyamide (A-1) in the compression limiter according to the invention, suitably comprises at least 70 mole % of terephthalic acid, naphthalene dicarboxylic acid or biphenyl dicarboxylic acid, or a combination thereof, relative to the total molar amount of aromatic dicarboxylic acid. Preferably, at least 70 mole %, more preferably at least 80 mole % of the aromatic dicarboxylic acid consists of terephthalic acid.

The aromatic dicarboxylic acid in the semi-crystalline semi-aromatic polyamide (A-1) may comprise other aromatic dicarboxylic acids, for example isophthalic acid. However, the amount thereof is preferably limited to at most 20 mole %, and more preferably is limited to a range of 0-10 mole %, relative to the total molar amount of aromatic dicarboxylic acid. The advantage thereof is that the load bearing properties at high temperature are better retained.

The semi-crystalline semi-aromatic polyamide (A-1) optionally comprises repeat units derived one or more other monomers, however the amount thereof is at most 5 mole %, and preferably in the range of 0-2.5 mole %, relative to the total molar amount of diamine, aromatic dicarboxylic acid and other monomers. Other monomers are for example monofunctional amines (monoamines) and monofunctional carboxylic acids (monoacids), which can be used as chain stoppers, and trifunctional amines (i.e. triamines) and trifunctional amines carboxylic acids (i.e. tri-acids), which can be used as branching agents.

The composition of which the compression limiter according to the invention comprises a fibrous reinforcing agent. Suitably, the fibrous reinforcing agent comprises glass fibers or carbon fibers, or a combination thereof. The amount of fibrous reinforcing agent has to be within the range of 35-65 wt. %. With a too low content, below 35 wt %, the load bearing properties at elevated temperature will suffer, whereas with too high a low content, above 65 wt %, the load bearing properties of the compression limiter as such will be too low. Within this range the fibrous reinforcing agent can be varied depending on the load bearing properties required and the fiber length applied. With a longer median fiber length and lower load bearing properties required the amount is suitably about 30 wt. % or somewhat above. With a shorter median fiber length and higher load bearing properties required the amount is suitably about 70 wt. % or somewhat below. The fibrous reinforcing agent in the composition suitably has a median fiber length in the range of 0.05-1 mm, preferably 0.1-0.5 mm, more particular in the range of 0.15-0.35 mm.

Herein the median fiber length is the length value at which 50 wt. % of the fibers have a lower length and 50 wt. % have a longer length. The median fiber length is determined by taking a representative sample of the fibers in the composition, making a microscopic picture of that sample and measuring the length of all the individual glass fibers in the sample. The fibers are considered to be equal for all, based upon which the length of the fibers is also directly representative for the weight of the fibers.

The composition used in the compression limiter may comprise other components in limited amounts, such as inorganic fillers (component C) and other polymers (component D), as well as further additives. Herein other polymers under component (C) are herein meant polymers other than the polyamide component (A). With further additives under component (D) are herein meant components different from different from components (A)-(D). The amounts of (C), (D) and (E) shall be limited in order not to corroborate the load bearing properties of the composition. Suitably, the said components are present in the following amounts:
(C) 0-10 wt. % of inorganic filler;
(D) 0-5 wt. % of another polymer; and
(E) 0-5 wt. % of at least one additive;
   wherein the weight percentages of (C) to (E) are relative to the total weight of the composition and the combined amount of (A)-(E) is 100 wt. %.

In an optimal composition,
polyamide component (A) is present in an amount of 40-60 wt. %;
the fibrous reinforcing agent (B) is present in an amount of 40-60 wt. %;
components (C) (D) and (E) are present, if at all, in a combined amount of 0-10 wt. %;
relative to the total weight of the composition.

Preferably, components (C) (D) and (E) are present, if at all, in a combined amount of 0-10 wt. %;

The composition of the thermoplastic material in the compression limiter not only has good mechanical properties at room temperature, but also at elevated temperature. Suitably, the thermoplastic material has a tensile modulus at 23° C. of at least 15,000 MPa, preferably at least 17,000 MPa, and more preferably at least 18,000 MPa, and tensile modulus at 120° C. of at least 10,000 MPa, preferably at least 12,000 MPa, and more preferably at least 14,000 MPa. Herein the tensile modulus is measured with the method according to ISO 6721-4:2008, at 10 Hz, using dry test samples (for instance until the mass of the samples remains constant for 3 consecutive days). The higher the tensile modulus at room temperature and at elevated temperature, the better the performance of the compression limiter under dynamic load bearing conditions.

The compression limiter according to the invention can be made with different shapes and variable dimensions, depending on the requirements of the applications wherein the limiter is used. Suitably, the compression limiter has a main body with a hollow pathway suited for receiving a bolt for mounting an assembly comprising the compression limiter. Suitably, the hollow pathway is a cylindrical pathway. A cylindrical pathway is a hole having a uniform circular cross section over the whole length of the hole. Such cylindrical pathway is ideally suited for receiving a bolt for mounting an assembly comprising the compression limiter.

In one embodiment, the compression limiter suitably has a main body with a uniform cylindrical shape. With a uniform cylindrical shape is herein understood a hollow shape defined by
an inner wall defining a cylindrical hollow pathway and having a uniform circular cross section over the whole length of the hollow pathway; and
an outer wall having a uniform circular cross section over the whole length of the main body.

In another embodiment, the compression limiter suitably has a main body with a tapered cylindrical shape. With a tapered cylindrical shape is herein understood a hollow shape defined by
an inner wall defining a cylindrical hollow pathway and having a uniform circular cross section over the whole length of the hollow pathway; and
and an outer wall having a gradually increasing circular cross section over the whole length of the main body.

The each of these embodiments the compression limiter suitably has a main body with a hollow pathway and an outer surface comprising recessions or protrusions.

The compression limiter suitably has a main body with a hollow pathway and a main body with a flanged end.

The compression limiter with one of these shapes, or modifications thereof, or combinations thereof, can be made by one-step injection molding, such injection molding process being well-known in the art. The modifications with either the tapered cylindrical shape, an outer surface comprising recessions or protrusions, or a flanged end, and combinations thereof, have the advantage that the compression limiter will be better frictionally retained in the thermoplastic body.

The preparation of the composition used for the compression limiter can suitably be done by a melt mixing process. Such a process may be carried out as known in the art, for example on a double screw extruder. For the preparation, suitably chopped glass fibers, or chopped carbon fibers, or a combination thereof, are used. Suitable, these chopped fibers have a length in the range of 0.5-5 cm, more particular in the range of 1.0-2.5 cm. During preparation, the process equipment and the conditions applied can be adjusted as known to the skilled person in the art, thereby reducing and optimizing the length of the fibers in the composition.

The invention also relates to a process for producing a compression limiter according to the present invention. The process according to the invention comprises a step, wherein a thermoplastic composition described above and also referred to as first thermoplastic composition, is melt extruded or injection molded, thereby forming a molded part with a hollow pathway.

In one embodiment, the process comprises a step wherein the thermoplastic composition is injection molded into a mold, by applying known methods in the art, the mold comprising a cavity having an appropriate shape, and a step of opening or removing the mold and discharging the resulting molded part from the mold, thereby obtaining a compression limiter according to the present invention. Herein the cavity may have one or more narrow gates. Despite the possible presence of weld lines, the compression limiter obtained has very good load bearing properties, and does not need post processing.

Advantageously, the compression limiter so produced by injection molding has either a tapered cylindrical shape, or an outer surface comprising recessions or protrusions, or a flanged end, or any combination thereof. The advantage thereof is the compression limiter is frictionally better retained in the assembly with the thermoplastic body.

In another embodiment, the process comprises a step wherein the thermoplastic composition is melt extruded, by applying any methods known in the art, thereby forming a hollow tube, and a step wherein the tube is partitioned into cylindrical parts, thereby obtaining one embodiment of the compression limiter according to the present invention. The advantage of the process is the resulting compression limiter has no weld lines (i.e. the fiber orientation showed no visual evidence of a knit line) and has further improved load bearing properties.

The invention also relates to an assembly comprising a thermoplastic body and at least one compression limiter. In the assembly according to the invention, the compression limiter is made of a first thermoplastic polyamide polymer composition and the thermoplastic body is made of a second polyamide polymer composition. Herein the compression limiter is made of a first polyamide polymer composition as defined herein above. In a preferred embodiment hereof, the thermoplastic body is made by overmolding the compression limiter with the second thermoplastic polyamide composition.

The advantage of the assembly according to the present invention is that the assembly has high load bearing properties over a wide temperature range, good adhesion between the compression limiter and the thermoplastic body, and a leak-tight sealing during prolonged operation under varying temperature and humidity conditions and dynamic mechanic loads.

The second thermoplastic material used for the thermoplastic body is a second polyamide polymer composition. This composition suitably is different from the first polymer composition and may comprise a polyamide different from the semi-aromatic polyamide in the first thermoplastic composition, and/or comprising less fibrous reinforcing agent than the first thermoplastic composition, or even no fibrous reinforcing agent at all. Suitably, the second thermoplastic polyamide material comprises a polymer component at least 50 wt. % thereof consisting of a semi-crystalline semi-aromatic polyamide with a melting temperature (Tm) below 270° C., or an aliphatic polyamide, or a combination thereof. Preferably, the second thermoplastic polyamide material comprises an aliphatic polyamide that may be chosen from PA-6, PA-66, PA46 and PA-410, and any copolyamide thereof. The second polyamide polymer composition may comprise, for example,
30-100 wt. % of said a semi-crystalline semi-aromatic polyamide with a melting temperature (Tm) below 270° C., or a thermoplastic aliphatic polyamide, or a combination thereof
0-30 wt. % of another polyamide than said semi-crystalline semi-aromatic polyamide or another polymer than said semi-crystalline semi-aromatic polyamide, or a combination thereof; and
0-60 wt %, preferably 0-30 wt. % of a fibrous reinforcing agent;
0-30 wt. % of an inorganic filler;
0-25 wt. % of at least one further additive;

wherein the percentages are relative to the total weight of the composition and the combined amounts of all said components add up to 100 wt. %.

Even though the load bearing properties of the second polyamide polymer composition and the thermoplastic body maid thereof, are much lower than those of the first polyamide polymer composition and the compression limiter made thereof, the performance of the assembly under load bearing mounting conditions is enhanced by the presence of the compression limiter according to the invention and the various embodiments thereof.

In an embodiment of the assembly according to the invention, the first thermoplastic material suitably has a tensile modulus at 120° C. with at least fifty percent (50%), and preferably with at least 75% greater than the tensile modulus of the second polymer composition at 120° C.

The invention also relates to a process for making the assembly. The process is an injection molding process, comprising steps of
providing a mold with a cavity;
providing at least one compression limiter in the cavity,
injection molding of a second thermoplastic polyamide composition into the cavity, thereby overmolding the compression limiter with the second thermoplastic polyamide composition and producing an injection molded thermoplastic body, and
removing the injection molded thermoplastic body with the overmolding the compression limiter integrated therein from the cavity
   wherein the compression limiter is made of first polyamide polymer composition as defined herein above.

The assembly according to the invention may be used for various applications, including automotive and E&E applications, and more particularly in engines, automotive power train systems, industrial machinery or electronic products. Particularly favorable, the assembly is an engine front cover, an intake manifold, an actuator housing or a part of a charging connector or a high voltage switch assembly.

The invention also relates to a construction comprising the assembly according to the invention, as described herein above, which is mounted on a carrier. Preferably, the assembly is mounted with at least one bold having a flange passing through a compressing limiter in the assembly or with a bold passing through a washer and the compressing limiter, the compressing limiter having an end section, wherein the surface of the washer or bold flange at least overlaps with and preferably extends beyond the end section surface of the compression limiter. This has the advantage that the assembly is even better secured on the carrier and the useful life-time of the construction under dynamic load, temperature and moisture conditions is enhanced.

The invention is further illustrated with the following Examples and Comparative Experiments

### Materials

PPA-1 An injection moldable polymer composition, comprising 50 wt. % of chopped glass fibers, 0.3 wt. % of auxiliary additives and 49.7 wt. % of a semi-crystalline semi-aromatic polyamide, the polyamide (PA) being PA-6T/4T/DT copolymer (58/32/10 molar ratio) composition (from DSM) that consists of repeat units derived from respectively: 1,6-hexanediamine and terephthalic acid (abbreviated as 6T), 1,4-butanediamine and terephthalic acid (abbreviated as 4T), and 2-methyl-pentamethylene diamine and terephthalic acid (abbreviated as DT). The polyamide has a Tg of 160° C. and a Tm of 335° C. The glass filled compound based on the copolymer has an elastic modulus at 23° C. of about 18000 MPa, and an elastic modulus at 200° C. of about 5500 MPa, said properties being measured with the methods described.
APA-1 An injection moldable polymer composition, comprising 50 wt. % of chopped glass fibers, 0.6 wt. % of auxiliary additives and 49.4 wt. % of a polyamide PA-66, the PA-66 having a Tm of 260° C. and prepared by a conventional process involving melt polymerization, followed by solid state post condensation (from DSM).

### Methods of Testing

The static strength under compression load was measured on test bars at 23° C. and 120° C., respectively on a standard tensile test machine. Test bars were prepared using either a single gated mold for standard test bars or a double gated mold for production of test bars with a weld line, each gate located at an opposite end of the sample and causing the formation of a weld line, while applying the same conditions as for standard test bars. The test bars (dimensions: outer diameter 14.4 mm, inner diameter 7.2 mm, and a length of approximately 28 mm) were first annealed for 1 week at 120° C. to eliminate post-crystallization effects during testing and then placed between two metal surfaces. The lower surface did not move, while the upper surface compressed the compression limiter until failure. The force (via a loadcell) that was applied and the travel distance of the upper surface of the compression limiter were measured. For the measurement at 120° C., the test was done inside an oven where the samples were heated up first during 30 minutes to 120° C. prior to the test.

For the force retention measurement, the test bars (dimensions: outer diameter 14.4 mm, inner diameter 7.2 mm, and a length of approximately 28 mm) were prepared using either a single gated mold for standard test bars or a double gated mold for production of test bars with a weld line, each gate located at an opposite end of the sample and causing the formation of a weld line, while applying the same conditions as for standard test bars. The test bars were first annealed for 1 week at 120° C. to eliminate post-crystallization effects during testing and then were placed in between a washer and a steel plate and bolted together with a M6 bolt, at room temperature (23° C., and 50% RH humidity conditions). A donut loadcell was placed in between the plate and compression limiter, which measured the force applied by the bolt towards the compression limiter. In this case, the bolt was tightened until a pre-tension force of 10 kN was reached. After 1 h, this setup was placed in an oven which was first at room temperature and then the oven was set at 120° C. After 8 hours the oven was switched off and the temperature cooled down to a temperature of 23° C.

### Production of the Compression Limiter by Injection Molding

### EXAMPLE 1

A mold was provided with a cylindrical cavity, outer diameter 14.4 mm, inner diameter 7.2 mm, and a length of approximately 28 mm. The PPA-1 was melt extruded and injected into the mold cavity using a standard extruder (single screw extruder) and injection molding machine. The setting temperature of the T-melt in the injection molding machine was about 350° C.; the temperature of the mold was about 140° C. The molded part was removed from the mold, thereby obtaining the injection molded compression limiter. Three specimens of the injection molded compression limiter of Example 1 were further tested as described herein above in Methods of testing.

### COMPARATIVE EXPERIMENT A

Example 1 was repeated except that APA 1 was used instead of PPA-1. The setting temperature of the T-melt in the injection molding machine was about 295° C.; the temperature of the mold was about 70° C.

### EXAMPLE 2

A mold was provided with a cavity having a three dimensional shape. The injection molded compression limiter of Example 1 was placed in the mold. The polymer composition APA-1 was melt extruded and injected into the mold cavity thereby overmolding the compression limiter. The molded part was removed from the mold, thereby obtaining the injection molded assembly of Example 2. Example 2 was repeated twice. Two specimens of the assembly of Example 2 were further tested.

### COMPARATIVE EXPERIMENT B

The production of the assembly of Example 2 was repeated except that instead of the injection molded compression limiter of Example 1, a metallic compression limiter was placed into the mold, and the metallic compression limiter was overmolded with APA-1.

### COMPARATIVE EXPERIMENT C

The production of the assembly of example 2 was modified such that instead of the injection molded compression limiter of Example 1, the compression limiter of Comparative A was placed into the mold, and overmolded with APA-1.

### Testing of the Compression Limiters

One specimen of each of the compression limiters were subjected to a compression test in a mechanical test apparatus as described herein above. The compression limiter of Example 1 withstood a much larger static compression failure force than the compression limiter of Comparative A (results obtained in Table 1).

Another specimen of each of the assemblies was subjected to a compression test wherein the retention of the compression force was tested. With the assembly of Comparative C the retention of the compression force was much worse compared to that of Example 1.

The results presented in Tables 1 and 2 demonstrate that the compression limiter according to the present invention showed high load-bearing properties over a wide temperature range, i.e. high static compression failure force and retention of compression force at 23° C. and 120° C., this also indicating good sealing performance.

TABLE 1

| | Static compression | Static compression |
|---|---|---|
| | failure force (kN) | failure force (kN) |
| Temperature | Example 1 | Comparative Example A |
| 23° C. | 27.5 | 21 |
| 120° C. | 17 | 9.5 |

TABLE 2

| | After | After | After | After |
|---|---|---|---|---|
| Time | 0 h | 1 h | 9 h | 24 h |
| Oven temperature | 23° C. | 23° C. | 120° C. | 23° C. |
| Retention force (kN) | 10 | 9.7 | 6.9 | 6.9 |
| Example 1 | | | | |
| Retention force (kN) | 10 | 9.2 | 3.2 | 2.1 |
| Comparative Experiment A | | | | |

1. Compression limiter made of a thermoplastic material, wherein the thermoplastic material comprises
(A) 35-65 wt. % of a polyamide component (A), wherein at least 90 wt. % of the polyamide component (A) consists of a semi-crystalline semi-aromatic polyamide (A-1), consisting of repeat units derived from
45-50 mole % of a diamine,
40-50 mole % of an aromatic dicarboxylic acid; and
0-10 mole % of one or more other monomers,
wherein the mole % is relative to the total molar amount of diamine, aromatic dicarboxylic acid and one or more other monomers,
and wherein (A-1) has a glass transition temperature (Tg) of at least 110° C. and a melting temperature of at least 280° C.; and
(B) 35-65 wt. % of a fibrous reinforcing agent,
wherein the weight percentages of (A) and (B) are relative to the total weight of the composition.

2. Compression limiter according to claim 1, wherein the semi-crystalline semi-aromatic polyamide (A-1) has a glass transition temperature (Tg) in the range of 120-170° C. and a melting temperature in the range of 290-340° C.

3. Compression limiter according to claim 1, wherein
at least 70 mole % of the diamine is a linear or branched aliphatic C4-C10 diamine, or a cycloaliphatic diamine, or a combination thereof
at least 70 mole % of the aromatic dicarboxylic acid is terephthalic acid, naphthalene dicarboxylic acid or biphenyl dicarboxylic acid, or a combination thereof
the amount of repeat units derived one or more other monomers is 0-5 mole %, wherein the mole % is relative to the total molar amount of diamine, aromatic dicarboxylic acid and one or more other monomers.

4. Compression limiter according to claim 1, wherein
polyamide component (A) is present in an amount of 40-60 wt. %
the fibrous reinforcing agent (B) is present in an amount of 40-60 wt. %;
0-10 wt. % of inorganic filler;
0-5 wt. % of another polymer; and
0-5 wt. % of at least one additive;
wherein the weight percentages of (A) to (E) are relative to the total weight of the composition and the combined amount of (A)-(E) is 100 wt. %.

5. Compression limiter according to claim 1, wherein the reinforcing agent comprises glass fibers or carbon fibers, or a combination thereof.

6. Compression limiter according to claim 1, wherein the thermoplastic material has an elastic modulus at 23° C. of at least 10,000 MPa, preferably at least 12,500 MPa, and more preferably at least 15,000 MPa, and an elastic modulus at 200° C. of at least 4,000 MPa, preferably at least 5,000 MPa, and more preferably at least 6,000 MPa.

7. Compression limiter according to claim 1, wherein the compression limiter comprising a main body having
a cylindrical shape, optionally a tapered cylindrical shape, or
an outer surface comprising recessions or protrusions, or
a flanged end, or
any combination thereof.

8. Assembly comprising a thermoplastic body and at least one compression limiter, wherein the compression limiter is made of a first thermoplastic polyamide polymer composition and the thermoplastic body is made of a second polyamide polymer composition and wherein the first polyamide polymer composition has a composition as defined in claim 1.

9. Assembly according to claim 8, wherein the first thermoplastic material has an elastic modulus at 23° C. at least fifty percent (50%) greater than the elastic modulus at 23° C. of the second polymer composition.

10. Assembly according to claim 8, wherein the second thermoplastic material comprises a polymer component at least 50 wt. % thereof consisting of a thermoplastic aliphatic polyamide, preferably chosen from PA-6, PA-66, PA46 and PA-410, and any copolyamide thereof.

11. Assembly according to claim 8, wherein the assembly is an engine front cover, an intake manifold, an actuator housing or a part of a charging connector or a high voltage switch assembly.

12. Process for producing an assembly according to claim 8, comprising steps of
providing a mold with a cavity;
providing at least one compression limiter in the cavity,
injection molding of a second thermoplastic polyamide composition into the cavity, thereby overmolding the compression limiter with the second thermoplastic polyamide composition and producing an injection molded thermoplastic body, and
removing the injection molded thermoplastic body with the overmolding the compression limiter integrated therein from the cavity
wherein the at least one compression limiter is made of first polyamide polymer composition.

13. Use of an assembly according to claim 8 in engines, automotive power train systems, industrial machinery or electronic products.

14. Construction comprising an assembly according to claim 8 mounted on a carrier, preferably mounted with at least one bold having a flange passing through a compressing limiter in the assembly or with a bold passing through a washer and the compressing limiter, the compressing limiter having an end section, wherein the surface of the washer or bold flange at least overlaps with and preferably extends beyond the surface of the end section of the compression limiter.
